(19) United States
(12) Patent Application Publication
(10) Pub. No.: US 2012/0170038 A1
(43) Pub. Date: Jul. 5, 2012

(54) Alignment Method for Inspecting a Mirror

(75) Inventors: Rémi Bourgois, Paris (FR); Emmanuel Carnis, Paris (FR)

(73) Assignee: SAGEM DEFENSE SECURITE, Paris (FR)

(21) Appl. No.: 13/496,614

(22) PCT Filed: Sep. 8, 2010
(86) PCT No.: PCT/FR2010/051868

§ 371 Date: Mar. 16, 2012

(30) Foreign Application Priority Data
Sep. 17, 2009 (FR) 09 56396

(51) Int. Cl. G01B 11/00

(52) U.S. Cl. 356/400

(57) ABSTRACT

An alignment method for controlling a mirror (100) makes it possible to orient an optical compensation digital hologram (3) relative to a mirror control tool. The control tool is designed to light up, one by one, confined portions (S10) of a reflecting surface (S100) of the mirror, and the entire surface is controlled while moving a lighting and image capture assembly (20), between a series of views, over the mirror. The control tool can then be of small size, even when the mirror has a very low curvature and a large size.

The present invention relates to an alignment method for inspecting a mirror, notably for inspecting the surface of an off-axis aspherical mirror.

The production of a mirror, such as a telescope mirror, comprises inspections of the mirror which are carried out during the manufacture of the mirror, according to an iterative process of inspections and of re-working of the surface of the mirror. The inspection consists in searching for and measuring any differences between the real shape of the reflecting surface of the mirror and a theoretical surface of the specifications of the mirror, referred to as target surface.

Such an inspection can be carried out on the whole mirror, or else on an element of this mirror when the mirror is composed of several mirror elements which are separate and designed to be juxtaposed to reconstitute the complete mirror. In the following, a whole mirror or a mirror element will simply be called mirror, it being understood that the inspection method is applied to a monolithic element having a reflecting surface.

To a first order, the surface of an off-axis aspherical mirror can be described by a value of average curvature and a value of average astigmatism which are established over the whole of the surface. However, the local value of curvature and the local value of astigmatism vary with respect to these average values, and are different between points that are apart on the surface of the mirror. Furthermore, additional terms are often needed in order to describe more exactly the shape of the surface of the mirror: coma, spherical aberration, etc. The object of the inspection is to measure the differences in these terms at every point on the surface of the mirror, between the real values and the values for the target surface.

One usual method for carrying out such an inspection consists in illuminating the whole of the mirror with a suitable light source, most often a laser source, through an optical compensator or ‘null-lens’. The null-lens is designed to compensate for a wavefront deformation that would be produced by the target surface of the mirror. The nature of the null-lens is not determined a priori, but holograms are often used because they can be generated digitally starting from the target surface, which is particularly convenient. Such a digital hologram is commonly denoted by CGH for “Computer-Generated Hologram”. An optical interference is then generated between a reference wavefront and a wavefront which is produced by reflection of the light on the mirror through the optical compensator. This interference produces a two-dimensional distribution of light intensity, or interference figure, which is characteristic of the difference between the real surface of the mirror and the target surface. Such an interference figure comprises light fringes when the two wavefronts are sufficiently different.

For this purpose, the inspection tool used comprises:
a first support, which is designed to maintain the mirror in a given position with respect to the inspection tool;
the optical compensator, which itself comprises the digital hologram, with a useful part of this digital hologram which contains a pattern calculated according to the target surface of the mirror;
a second support, which is designed to hold the optical compensator for an image capture time, the second support also being designed to laterally translate the optical compensator along transverse directions of the inspection tool, and to rotate the optical compensator about a longitudinal axis of the inspection tool;
the light source, which is designed to produce a light beam when an image is captured, and arranged so as to illuminate the reflecting surface of the mirror through the digital hologram of the optical compensator, parallel to the longitudinal axis;
an optical system, which is designed to produce an interference between a reference part of the light beam produced by the source and a part of this light beam reflected by the mirror through the digital hologram of the optical compensator; and
an image recording system, which is disposed to capture a distribution of light intensity produced by the interference, and superimposed onto an image of the mirror formed by the part of the light beam reflected by this mirror.

Usually, the optical compensator is placed at a distance from the mirror that allows an image of the whole of its reflecting surface to be obtained, onto which the interference figure is superimposed. Thus, a single photograph allows the whole surface of the mirror to be inspected. In the jargon of the industry, such an inspection is referred to as “full pupil mode”. For this mode, the distance between the light source and the mirror must be substantially equal to the average radius of curvature of the reflecting surface of the latter.

It is then easy to orient the optical compensator with respect to the mirror, by rotating the compensator about the longitudinal axis of the inspection tool. Indeed, the hologram of the compensator and the first support comprise alignment features which are simultaneously visible in the image captured by the image recording system, and the position of the mirror on the first support is known from elsewhere. Respective reference directions of the optical compensator and of the mirror are thus brought parallel to one another. These reference directions are generally respective astigmatism axes of the optical compensator and of the mirror.

Now, for a telescope primary mirror, the average radius of curvature of the mirror can be several tens of meters. Given that the dimensions of the holographic compensator are limited to a few tens of centimeters by its fabrication, the distance between the optical compensator and the mirror should be very large in order to carry out an inspection of the mirror in full pupil mode. But when this distance exceeds around 3 m (meters), gaseous turbulence and variations of temperature appear between the compensator and the mirror, and perturb the interference figure.

It may also be envisioned to inspect a mirror that has a large radius of curvature by bringing the optical compensator up close to the reflecting surface of the mirror. However, a telescope mirror generally has lateral dimensions that can also be very large, in particular greater than 1 m, or even greater than 1.5 m. So only a restricted part of the surface of the mirror, commonly called “sub-pupil”, can be illuminated through the optical compensator while a photograph is captured by the image recording system. The surface inspection which results from this photograph is consequently limited to this part of the surface of the mirror. Several photographs must therefore be captured successively for different parts of the surface of the mirror respectively, in order to allow the entire surface to be inspected. The optical compensator must therefore be displaced with respect to the mirror between successive photographs.

Various methods exist for determining very precisely the directions of displacement of the optical compensator with respect to the mirror, and also for determining a reference point for the displacements of the optical compensator. Starting from here, one object of the present invention is to orient the optical compensator about the longitudinal axis of the inspection tool, where only a restricted part of the surface of the mirror is illuminated when each photograph is taken through the optical compensator.

For this purpose, the invention provides an alignment method for inspecting a mirror using an optical inspection tool that comprises the elements listed above, and in which:
the light source only illuminates one part of the reflecting surface of the mirror when one given photograph is captured by the image recording system, this surface part which is illuminated being smaller than the entire reflecting surface of the mirror;
the first support is equipped with at least one reflecting alignment feature; and
the digital hologram of the optical compensator furthermore comprises at least two first additional patterns which are disposed on two first sides of the useful part of the digital hologram, each first additional pattern being designed to produce an optical lens effect such that an alignment light beam which is directed toward the alignment feature through this first additional pattern is reflected in a variable manner as a function of a transverse shift of the first additional pattern with respect to the alignment feature.

The method of the invention then comprises the following sequence of steps, which is potentially repeated several times:

/1/ directing an alignment light beam through one of the first additional patterns and detecting the alignment light beam which is reflected by the alignment feature, by translating transversally the second support with respect to the first support so as to align the first additional pattern of the digital hologram with respect to the alignment feature of the first support, parallel to the longitudinal axis of the inspection tool;

/2/ again, laterally translating the second support, without rotating it, with a suitable translation vector so that an alignment beam that passes through another of the first additional patterns of the digital hologram is again reflected by the same alignment feature of the first support in an aligned manner between this alignment feature and this other first additional pattern parallel to the longitudinal axis of the inspection tool;

/3/ based on components of the vector for the translation of the second support which is carried out in the step /2/, in one and the other of the transverse directions respectively of the inspection tool, determining an angular separation between one of these transverse directions and a reference direction of the useful region of the digital hologram which is located by the first additional patterns; then

/4/ rotating the second support about the longitudinal axis of the inspection tool according to the angular separation determined in the step /3/, so as to set the reference direction of the useful region of the digital hologram parallel to a reference direction of the mirror.

In the step /2/, the optical compensator is translated so as to replace a first of the additional patterns of the hologram of the optical compensator by a second additional pattern of the latter, in the position in line with the alignment feature of the first support. The direction of this translation is then used as a reference direction which is fixed with respect to the inspection tool. It is determined by the two components of the translation vector along the transverse directions of the inspection tool. The initial angular orientation of the optical compensator in the plane of these transverse directions, in other words around the longitudinal axis of the inspection tool, can then be determined with respect to the inspection tool. It is determined in step /3/ by using a reference direction which is linked to the optical compensator. The orientation of the optical compensator with respect to the inspection tool can then be modified in the step /4/ by rotating the second support around the longitudinal axis.

Since the orientation of the mirror with respect to the inspection tool is assumed to be known with precision from elsewhere, the method of the invention leads to a precise value of the angular orientation of the optical compensator with respect to the mirror. In particular, it allows the respective astigmatism axes of the optical compensator and of the mirror to be angularly superimposed.

In a convenient manner, the orientation of the optical compensator can be determined by the two first additional patterns themselves, which have respectively been used in steps /1/ and /2/. Nevertheless, the orientation of the optical compensator may be determined in a different manner.

In one preferred embodiment of the invention, the respective first sides of the two first additional patterns of the optical compensator are opposing with respect to the useful region of the digital hologram. In addition, they may determine an astigmatism axis of the optical compensator.

According to one possible improvement of the invention, the digital hologram of the optical compensator may furthermore comprise a further first additional pattern, which is disposed on another side of the useful part of the digital hologram different from the two first sides. This further first additional pattern is also designed to produce an optical lens effect such that an alignment light beam which is directed toward the alignment feature through this further first additional pattern is reflected in a variable manner as a function of a transverse shift of the further first additional pattern with respect to the alignment feature. The steps /1/ to /3/ may then be repeated for one of the first additional patterns used previously and for the further first additional pattern. In this way, another angular separation can be determined in the step /3/, which forms a measurement of an angle between the two transverse directions of the inspection tool. Thus, the positions of at least three first additional patterns in the digital hologram, around the useful region of the latter, are used for measuring the angle between the two transverse translation directions of the second support. In particular, perpendicularity between these two translation directions of the second support can be verified, by taking as reference.

The method may furthermore comprise several steps for capturing photographs, two successive photographs being separated by intermediate steps for translation of the optical compensator with respect to the mirror. In this way, different parts of the reflecting surface of the mirror can be inspected successively, where desired until the entire surface is inspected part by part.

A method according to the invention may be used, in particular, for inspecting the reflecting surface of an off-axis aspherical mirror.

Other features and advantages of the present invention will become apparent in the description hereinafter of non-limiting exemplary embodiments, with reference to the appended drawings, in which:

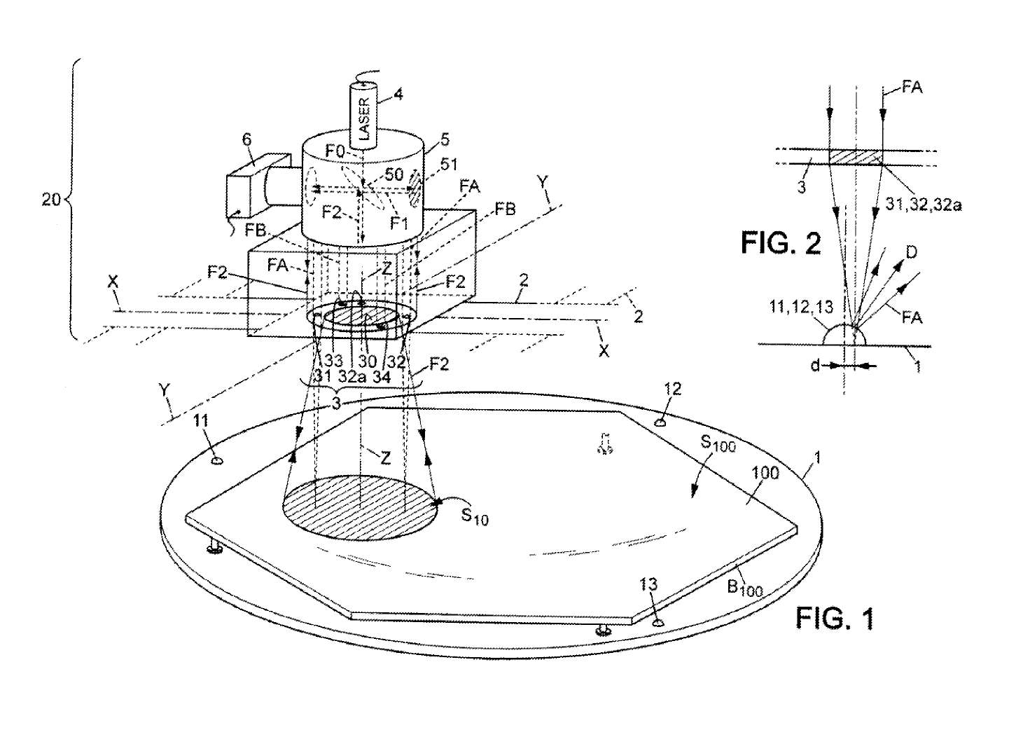

FIG. 1 shows an inspection tool for a mirror designed for using a method according to the invention;

FIG. 2 illustrates a principle of alignment, used in the invention, between a holographic pattern and an alignment feature; and

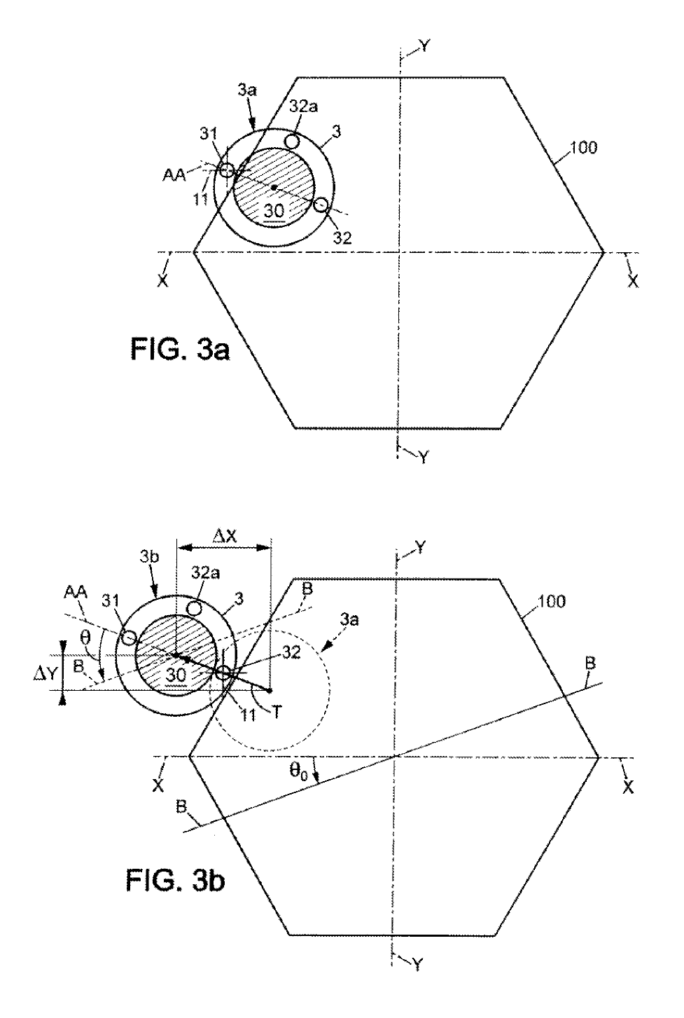

FIGS. 3a and 3b illustrate successive steps of a method according to the invention.

For reasons of clarity, the components of the inspection tool which are shown in these figures are neither reproduced according to real dimensions, nor according to ratios of actual dimensions. Furthermore, identical references which are indicated in different figures denote elements which are identical.

According to FIG. 1, a mirror inspection tool comprises a mirror support, also denoted by first support and reference 1, and an optics support, also denoted by second support and reference 2.

The mirror to be inspected, reference 100, is fixed onto the support 1 so as to expose its reflecting surface S₁₀₀. It may in particular be of the off-axis aspherical mirror type. The mirror 100 has a peripheral edge B₁₀₀ which limits the surface B₁₀₀ in a transverse direction. For example, this edge B₁₀₀ may be hexagonal with a diameter greater than or equal to 1500 mm (millimeter) between opposing apices of the hexagon.

The support 1 furthermore comprises one or more reflecting alignment feature(s) which is (are) fixed onto the support 1, and preferably situated close to and outside of the peripheral edge B₁₀₀ of the mirror 100. For example, the support 1 may be equipped with three reflecting alignment features which are referenced 11, 12 and 13, and which may be distributed over the support 1 around the mirror 100 and be angularly separated from one another by around 120°.

The optics support 2 is mobile with respect to the mirror support 1. It comprises the following components which form an illumination and image capture assembly with overall reference 20:
an optical compensator, which will be described hereinbelow;
a light source 4, for example of the laser type;
an optical system 5, whose functions are to transmit a part of the light which is produced by the source 4 in order to illuminate a part of the mirror 100 through the optical compensator, and to generate a light interference between a beam which is reflected by the mirror 100 and a reference beam; and
an image recording system 6, which is disposed for capturing an image of the part of the mirror 100 which is illuminated through the optical compensator.

Such an illumination and image capture assembly is known to those skilled in the art, so that only a succinct description of this is presented here.

Inside the optical system 5, an initial beam F0 produced by the source 4 is divided into a reference beam F1 and an illumination beam F2. This division of the beam F0 may be achieved by a semi-reflecting plate 50. In addition, a beam return mirror 51 may be disposed in the path of the reference beam F1. At the exit of the system 5, the illumination beam F2 preferably has a parallel beam structure, with a beam cross-section that is greater than or equal to an opening of the optical compensator. For example, the opening of the optical compensator can have a diameter in the range between 250 and 300 mm. The direction of the beam F2 is referred to as the longitudinal axis of the inspection tool, and is denoted Z-Z. The illumination beam F2 then passes through the optical compensator a first time, is reflected by a part of the surface S₁₀₀ of the mirror 100, again passes through the optical compensator in the reverse direction, then is superimposed onto the reference beam F1 within the system 5. This superimposition produces an interference figure in an image of the illuminated part of the surface S₁₀₀. This image is captured with the interference figure by the image recording system 6 when a photograph is taken. It is then possible, based on the variations in light intensity which are present in the image, to obtain a measurement of local differences existing between the surface S₁₀₀ and a target surface which is recorded in the null-lens. Generally speaking, the variations in light intensity that are present in the image of the illuminated part of the mirror 100 form a pattern of interference fringes, whose local orientation and local spacing allow the difference between the real surface S₁₀₀ of the mirror 100 and the target surface to be determined.

The distance between the illumination and image capture assembly 20 and the mirror 100, parallel to the axis Z-Z, is such that only a restricted part S₁₀ of the reflecting surface S₁₀₀ of the mirror 100 is illuminated when each photograph is taken. For example, the illuminated part S₁₀ may be ten to a hundred times smaller than the whole of the surface S₁₀₀. Thus, for a fixed size of the opening of the optical compensator, the inspection of the surface S₁₀₀ that can be carried out based on a single captured image is limited to this surface part S₁₀. This limitation allows the distance between the mirror 100 and the illumination and image capture assembly 20 to be reduced, so that the design of the inspection tool is simplified. The cost of this tool is decreased as a result.

The support 2 allows the illumination and image capture assembly 20 to be displaced by translation above the surface S₁₀₀ of the mirror 100, along two transverse directions X-X and Y-Y that are perpendicular to the longitudinal axis Z-Z, or substantially perpendicular to this axis Z-Z. For this purpose, the support 2 comprises a system of sliders and a system for measurement of translation distances, not shown in FIG. 1. This system allows translation distances to be achieved which are sufficiently large for the surface part S₁₀ that is illuminated to be able to be brought to any given location within the entire surface S₁₀₀. The translation directions X-X and Y-Y are usually perpendicular to each other, but they could have an additional angular separation between them with respect to 90° (degrees).

The support 2 also allows the optical compensator to be rotated about the longitudinal axis Z-Z, and the angle of such a rotation of the optical compensator can be determined with precision.

The two directions X-X and Y-Y, together with the longitudinal axis Z-Z, define a system of coordinates which is linked to the inspection tool. This coordinate system allows the position of the support 2 to be located, together with the angular orientation of the null-lens about the longitudinal axis Z-Z.

The optical compensator comprises a hologram CGH which is referenced 3. Usually, when the whole surface S₁₀₀ is illuminated simultaneously by the illumination and image capture assembly 20, a useful part 30 of the hologram 3 is determined to compensate for the variations in optical path length within the illumination beam F2, which are due to the shape of the target surface of the mirror 100. The optical paths considered correspond to rays of the illumination beam which are reflected at different points on the mirror, and their lengths are calculated between the division and the regrouping of the beams F1 and F2 which are produced by the semi-reflecting plate 50. Thus, if the mirror 100 possesses a shape which is strictly identical to the target surface, the image that is captured exhibits a uniform intensity. In contrast, variations in intensity in the captured image reveal and enable the determination of differences between the real surface and the target surface of the mirror at the location of these variations in intensity. However, for these variations in intensity to be representative of the shape of the mirror 100, the holographic compensator must be rotated about the longitudinal axis Z-Z until the orientation of the target surface which is integrated into the hologram 3 corresponds precisely to the orientation of the mirror 100 in the inspection tool. In other words, respective reference directions of the hologram 3 and of the mirror 100 must be parallel.

In an inspection method according to the invention where the illuminated surface part S₁₀ is smaller than the entire surface S₁₀₀ of the mirror 100, the same optical compensator hologram 3 is used for all the different parts of the surface S₁₀₀ which will be successively illuminated. Under these conditions, the useful part 30 of the hologram 3 of the optical compensator performs an average sphere and astigmatism compensation which is established for the whole of the target surface of the mirror 100. Where desired, the useful part 30 of the hologram 3 could simultaneously compensate for other average optical characteristics of the target surface. For each part of the surface S₁₀₀ that is illuminated when successive photographs are taken, this surface part is inspected by measuring the variations in light intensity that are present within the interference figure captured. These variations in light intensity allow the differences between the real surface part S₁₀ and the average characteristics of the target surface, which are integrated into the useful part 30 of the hologram 3, to be calculated. These differences are then compared with those that exist between the local characteristics of the target surface and its average characteristics, in particular for the sphere and astigmatism values. The compensation by the hologram 3 for the average characteristics of the target surface allows the precision of the inspection of the real surface S₁₀₀ to be improved.

It is therefore necessary to precisely orient the hologram 3 of the optical compensator with respect to the mirror 100. It is then assumed that the position of the mirror 100 on the support 1, and the position of the support 1 within the inspection tool are furthermore determined with precision, in a manner that is not a subject of the present invention. The method of the invention that is now described allows the hologram 3 of the optical compensator to subsequently be oriented with respect to the inspection tool, the latter being determined by the transverse directions X-X and Y-Y of displacement of the support 2, and by the longitudinal axis Z-Z. However, such an adjustment in orientation is not straightforward, in particular because the image that is captured does not reproduce the whole surface S₁₀₀, but only a restricted part of the latter. In particular, the alignment features 11-13 of the support 1 are not visible in this image, or any two of the latter are not visible simultaneously in the same image which is captured by the image recording system 6.

According to one feature of the invention, the hologram 3 of the optical compensator comprises at least two first additional holographic patterns, which each produce an optical lens effect. Preferably, they each produce a converging optical lens effect, and the focal distance that is associated with each of these first patterns may approximately correspond to the separation distance between the hologram 3 and each of the alignment features 11-13, measured along the axis Z-Z. These first additional patterns are disposed on different sides of the useful part 30 of the hologram 3. Their respective positions around the useful part 30 are known with precision, thanks to the digital technology which is used to generate the hologram. For example, three first additional holographic patterns 31, 32 and 32a, which may be identical, are provided around the useful part 30 of the hologram 3. The patterns 31 and 32 may be disposed on two opposing sides of the useful part 30, so as to identify a reference direction A-A of the hologram 3, and the pattern 32a may be situated at 90° between the patterns 31 and 32. For example, the reference direction A-A (FIGS. 3a and 3b) which is identified by the holographic patterns 31 and 32 can correspond to an average astigmatism axis of the target surface.

As shown in FIG. 2, each reflecting alignment feature 11-13 which is provided on the support 1 may have a convex spherical shape when each of the holographic patterns 31, 32 and 32a produces a converging optical lens effect. In particular, each alignment feature 11-13 may be similar to a hemispherical metal bead, for example of 1 mm radius. In this case, an alignment light beam which passes through one of the holographic patterns 31, 32 or 32a and which is directed onto one of the alignment features 11-13 is reflected by the latter around a variable central direction D. This direction of reflection D depends on an offset d between the holographic pattern and the alignment feature. The central direction of reflection D is then detected. In this way, the offset d can then be compensated with precision by displacing the support 2. According to one particularly advantageous embodiment of the invention, the alignment beam may be a part FA of the illumination beam F2 which passes through one of the holographic patterns 31, 32 or 32a. The alignment beam which is reflected by the alignment feature can then be detected by the system 6 in the image that is captured. In this way, the optics support 2 can be displaced in order to bring any of the patterns 31, 32 or 32a very precisely into line with any one of the alignment features 11-13.

A first step of a method according to the invention then consists in aligning the holographic pattern 31, parallel to the longitudinal axis Z-Z and in the manner that has just been described, with the alignment feature 11. For this purpose, the support 2 can be translated in the two transverse directions X-X and Y-Y, and potentially rotated about the longitudinal axis Z-Z. FIG. 3a is a view along the axis Z-Z, which shows such a position 3a of the hologram 3 in which the alignment feature 11 and the holographic pattern 31 are aligned. The central point of the alignment feature 11 is symbolically represented by a cross.

In a second step, which is carried out using this position 3a of the hologram 3, the support 2 is again translated in one of the two transverse directions X-X and Y-Y, in order to now align the holographic pattern 32 with the alignment feature 11 parallel to the longitudinal axis Z-Z. This new alignment is again detected in the same way, but during this second step, the support 2 is only translated without being rotated about the axis Z-Z. FIG. 3b shows the position 3b of the hologram 3 at the end of this second step. The position 3a that was occupied after the first step is also shown with a dashed line. The vector of the translation that has been carried out during this second step is denoted T. It is parallel to the reference direction A-A of the hologram 3 which is identified by the patterns 31 and 32. The components of the vector T are the displacements ΔX and ΔY of the support 2 which have been applied during the second step, in the two respective transverse directions X-X and Y-Y of the inspection tool. They are read with precision in these transverse directions.

In a third step, the optics support 2 is rotated around the longitudinal axis Z-Z in order to set the reference direction A-A of the hologram 3 parallel to a reference direction of the mirror 100, denoted B-B. The initial orientation of the direction A-A is that of the second step, and is known with precision by the components ΔX and ΔY of the vector T. Thus, the direction A-A of the hologram 3 can be rotated in order to come precisely into parallel with the reference direction B-B of the mirror 100. For example, the angle θ of rotation of the optics support 2 which is applied can be calculated by the following formula:

θ=−Arctan(ΔY/ΔX)+θ₀

where Arctan is the inverse of the trigonometric function tangent, and θ0 is the angle between the transverse direction X-X and the reference direction B-B of the mirror 100. The angles θ and θ0 are indicated in FIG. 3b. The angle Arctan (ΔY/ΔX) represents the orientation of the reference direction A-A of the hologram 3 with respect to the axis X-X at the end of the second step.

If required, the second step of the method could be repeated using the holographic pattern 32a instead of the pattern 32. A second translation vector is then determined by its components in the transverse directions X-X and Y-Y. This second vector allows the angle which angularly separates these directions X-X and Y-Y to be verified with precision, by taking as reference the angle which is present between the direction A-A and the direction of the pattern 32a inside of the hologram 3. This is because the latter angle is defined very precisely by the process of fabrication of the digital hologram. In an analogous manner, the graduations of the inspection tool which determine the position of the support 2 can be calibrated with respect to the positions of the holographic patterns 31, 32 and 32a in the hologram 3.

When the support 1 is equipped with several reflecting alignment features, the first step, which has been previously described, can be repeated for each of these alignment features by each time using the same first additional pattern of the digital hologram 3. For example, the first step is carried out successively with the alignment features 11, 12 then 13 always using the pattern 31. By each time noting the position of the support 2 which is read in the transverse directions X-X and Y-Y, graduations of the inspection tool that locate the position of the support 2 can also be calibrated in this way, with respect to the alignment features 11-13 of the support 1.

A first optional improvement of the invention, which is now described, allows the orientation of the hologram 3 of the optical compensator to be located with respect to the image recording system 6.

For this purpose, the digital hologram 3 can furthermore comprise at least two second additional patterns, which are disposed on two second sides of the useful part 30, each second additional pattern being designed to reflect an orientation light beam. In other words, each second additional pattern has an optical mirror effect for the orientation light beam which is incident on the hologram at the location of this second additional pattern. Preferably, the optical effect of each second additional pattern is that of a plane mirror.

In FIG. 1, the hologram 3 comprises the two second additional holographic patterns which are referenced 33 and 34. They may be situated on opposing sides of the useful part 30. Each of the patterns 33 and 34 is a plane holographic mirror, which reflects an orientation light beam FB. Advantageously, each beam FB is a part of the illumination beam F2 which is produced by the light source 4, so that positions of the patterns 33 and 34 are captured by the image recording system 6. The second patterns 33, 34 thus form a system of alignment features for orientation of the digital hologram 3 with respect to the image recording system 6.

According to a second optional improvement of the invention, the optical compensator may furthermore comprise at least two marks which are disposed so as to be visible in the image of the mirror captured by the image recording system. Such marks allow a magnification of the image that is captured to be determined based on distances between the marks which are respectively measured in the optical compensator and in the captured image. In one preferred embodiment of this improvement, the two marks are included within the digital hologram 3 of the optical compensator. In this case, they can respectively be coincident with the second additional holographic patterns 33 and 34 of the digital hologram 3, introduced for the first improvement of the invention.

When the orientation of the hologram 3 of the optical compensator has been precisely determined with respect to the inspection tool, and after the hologram 3 has been suitably oriented with respect to a reference axis of the mirror 100, the inspection of the surface S₁₀₀ can be started. For this purpose, the illumination and image capture assembly 20 is translated, without being rotated, in line with a selected part of the mirror 100. An image is then captured by the system 6, then the whole assembly 20 is again displaced by translation to a different part of the mirror 100. In this way, the whole of the surface S₁₀₀ is covered by successive photographs, such that the entirety of this surface can be compared with the target surface. The method of calculation of the difference between each part of the surface S₁₀₀ thus imaged and the corresponding part of the target surface of the mirror 100 is assumed to be known to those skilled in the art, and is not discussed here.

It will be understood that the embodiments of the invention that have just been described in detail may be modified or adapted while at the same time conserving at least some of the aforementioned advantages. In particular, the light which is used for each step of the alignment method, subject of the invention, may originate from an additional light source, separate from the source 4 which illuminates one part of the mirror 100 when the photographs are taken. Furthermore, the first holographic patterns 31 and 32 with lens effect are not necessarily situated at positions that are diametrically opposing with respect to the useful part 30 of the hologram 3.

Lastly, it will also be understood that the invention may be implemented with a beam of any given wavelength, even though the latter has been referred to as a “light beam”. In particular, it may be a beam of visible light or infrared, depending on the nature of the mirror to be inspected and/or on the nature of the inspection tool that is used.

1. An alignment method for inspecting a mirror using an optical inspection tool, said inspection tool comprising:
a first support designed to maintain the mirror in a determined position with respect to the inspection tool;
an optical compensator comprising a digital hologram, a useful part of said digital hologram containing a pattern calculated according to a target surface of the mirror;
a second support designed to maintain the optical compensator for an image capture time, the second support being furthermore designed to laterally translate said optical compensator along transverse directions of the inspection tool, and to rotate said optical compensator around a longitudinal axis of said inspection tool;
a light source designed to produce a light beam when an image is captured, and arranged so as to illuminate a reflecting surface of the mirror through the digital hologram of the optical compensator, parallel to the longitudinal axis;
an optical system designed to produce an interference between a reference part of the light beam produced by the source and a part of said light beam reflected by the mirror through the digital hologram of the optical compensator; and
an image recording system, disposed to capture, when each photograph is captured, a distribution of light intensity produced by the interference and superimposed onto an image of the mirror formed by the part of the light beam reflected by said mirror,
said method being characterized in that:
the light source only illuminates one part of the reflecting surface of the mirror when one given photograph is captured by the image recording system, said illuminated surface part being smaller than the entire reflecting surface of the mirror;
the first support is equipped with at least one reflecting alignment feature; and
the digital hologram of the optical compensator furthermore comprises at least two first additional patterns disposed on two first sides of the useful part of said digital hologram, each first additional pattern being designed to produce an optical lens effect such that an alignment light beam directed toward the alignment feature through said first additional pattern is reflected in a variable manner as a function of a transverse shift of said first additional pattern with respect to the alignment feature;
and in that the method comprises the following sequence of steps, potentially repeated several times:
/1/ directing an alignment light beam through one of the first additional patterns and detecting the alignment light beam reflected by the alignment feature, by translating transversally the second support with respect to the first support so as to align said first additional pattern of the digital hologram with respect to the alignment feature of the first support, parallel to said longitudinal axis;
/2/ again, laterally translating the second support, without rotating said second support, with a suitable translation vector so that an alignment beam passing through another of the first additional patterns of the digital hologram is again reflected by the same alignment feature of the first support in an aligned manner between said alignment feature and said other first additional pattern parallel to the longitudinal axis;
/3/ based on components of the vector for the translation of the second support carried out in the step /2/, in one and the other of the transverse directions respectively of the inspection tool, determining an angular separation between one of said transverse directions and a reference direction of the useful region of the digital hologram located by the first additional patterns; then
/4/ rotating the second support around the longitudinal axis according to the angular separation determined in the step /3/, so as to set the reference direction of the useful region of the digital hologram parallel to a reference direction of the mirror.

2. The method as claimed in claim 1, according to which the digital hologram (3) of the optical compensator furthermore comprises a further first additional pattern, disposed on another side of the useful part of said digital hologram different from the first two sides, said further first additional pattern also being designed to produce an optical lens effect such that an alignment light beam directed toward the alignment feature through said further first additional pattern is reflected in a variable manner as a function of a transverse shift of said further first additional pattern with respect to the alignment feature,
the steps /1/ to /3/ being repeated for one of said first additional patterns and for said further first additional pattern, so that another angular separation determined in step /3/ forms a measurement of an angle between the two transverse directions of the inspection tool.

3. The method as claimed in claim 1, furthermore comprising several steps for capturing photographs, two successive photographs being separated by intermediate steps for translation of the optical compensator with respect to the mirror.

4. The method as claimed in claim 1, according to which each alignment feature provided on the first support has a convex spherical shape and each first additional pattern of the digital hologram is designed to produce a converging optical lens effect, and according to which each alignment light beam is reflected by said alignment feature around a central direction being variable as a function of the transverse shift between the alignment feature and the first additional pattern through which said alignment light beam passes, said central direction of reflection of the alignment light beam being detected during steps /1/ and /2/.

5. The method as claimed in claim 1, according to which each alignment light beam is a part of the light beam produced by the light source, and according to which the alignment light beam reflected by the alignment feature is detected by the image recording system.

6. The method as claimed in claim 1, according to which the first support is equipped with several reflecting alignment features, and in that step /1/ is repeated for each of said alignment features with a same one of the first additional patterns of the digital hologram.

7. The method as claimed in claim 6, according to which the first support is equipped with three reflecting alignment features.

8. The method as claimed in claim 1, according to which the digital hologram furthermore comprises at least two second additional patterns disposed on second sides of the useful part of said digital hologram, each second additional pattern being designed to reflect an orientation light beam,
and according to which each orientation light beam directed onto one of the second additional patterns of the digital hologram is a part of the light beam produced by the light source, so that positions of said second additional patterns are captured by the image recording system.

9. The method as claimed in claim 1, according to which the optical compensator furthermore comprises at least two marks disposed in order to be visible in an image of the mirror captured by the image recording system, and according to which the method furthermore comprises a determination of a magnification of the captured image based on distances measured between the marks in the optical compensator and in said image, respectively.

10. The method as claimed in claim 9, according to which the two marks are included in the digital hologram.

11. The method as claimed in claim 6, according to which the two marks are respectively coincident with the two second additional patterns of the digital hologram.

12. An application of a method as claimed in claim 1, for inspecting the reflecting surface of an off-axis aspherical mirror.
